(19) United States
(12) Patent Application Publication
(10) Pub. No.: US 2015/0339651 A1
(43) Pub. Date: Nov. 26, 2015

(54) CASH FLOW ANALYTICS DRIVEN CORRESPONDENT BANK NETWORK OPTIMIZATION

(71) Applicant: International Business Machines Corporation, Armonk, NY (US)

(72) Inventors: Arun Hampapur, Norwalk, CT (US); Hongfei Li, Briarcliff Manor, NY (US); Robin Lougee, Yorktown Heights, NY (US); Buyue Qian, Ossining, NY (US)

(73) Assignee: International Business Machines Corporation, Armonk, NY (US)

(21) Appl. No.: 14/284,057

(22) Filed: May 21, 2014

(51) Int. Cl. G06Q 20/22; G06Q 20/10

(52) U.S. Cl. CPC G06Q 20/22; G06Q 40/02; G06Q 20/10

(57) ABSTRACT

A system, method and program product are provided for calculating a routing scheme for a set of correspondent banking (CB) transactions. The described system includes: a network modeling system that creates a model of a CB network for a set of banks based on existing relationships among and between the banks; and an optimization engine that generates a CB transaction routing scheme for an inputted set of CB transactions within the CB network, wherein the optimization engine provides an overall maximized economic benefit for executing each of the inputted set of CB transactions based on separately collected cost data, risk data and revenue data.

### TECHNICAL FIELD

The subject matter of this invention relates generally to bank-to-bank transactions within a correspondent bank network, and more particularly relates to an optimization system and method for routing transactions within a correspondent banking network to maximize economic benefit.

### BACKGROUND

Correspondent banking refers to a scenario in which a financial institution (i.e., bank) provides services on behalf of another, equal or unequal, financial institution. A correspondent bank can conduct business transactions, accept deposits and gather documents on behalf of the other financial institution. Correspondent banks are more likely to be used to conduct business in foreign countries, and act as a domestic bank's agent abroad. In many cases, a transaction such an international money transfer can involve intermediate transactions among multiple institutions along a network of banks having existing relationships with each other.

Currently, routing of bank-to-bank transactions is often determined in a brute force manner or based on human experience. However, the costs, risks and time involved in executing transactions between banks can vary from bank to bank. Accordingly, a selected route may not necessarily provide the most cost effective solution for a given transaction.

### SUMMARY

In general, aspects of the present invention provide a solution for analyzing the cash flow on a correspondent banking network, estimating the overall cost and risk of each route, and then rerouting the transactions among banks in the network such that the overall profit of correspondent banking is maximized.

A first aspect of the invention provides a system for calculating a routing scheme for a set of correspondent banking (CB) transactions, comprising: a network modeling system that creates a model of a CB network for a set of banks based on existing relationships among and between the banks; and an optimization engine that generates a CB transaction routing scheme for an inputted set of CB transactions within the CB network, wherein the optimization engine provides an overall maximized economic benefit for executing each of the inputted set of CB transactions based on separately collected cost data, risk data and revenue data.

A second aspect of the invention provides a computer program product stored on computer readable medium, which when executed by a computer system, calculates a routing scheme for a set of correspondent banking (CB) transactions, comprising: program code that creates a model of a CB network for a set of banks based on existing relationships among and between the banks; and program code that generates a CB transaction routing scheme for an inputted set of CB transactions within the CB network, wherein the CB transaction routing scheme provides an overall maximized economic benefit for executing the inputted set of CB transactions based on separately collected cost data, risk data and revenue data.

A third aspect of the invention provides a computerized method of calculating a routing scheme for a set of correspondent banking (CB) transactions, comprising: creating a model of a CB network for a set of banks based on existing relationships among and between the banks; and generating a CB transaction routing scheme for an inputted set of CB transactions within the CB network, wherein the optimization engine provides an overall maximized economic benefit for executing each of the inputted set of CB transactions based on separately collected cost data, risk data and revenue data.

### BRIEF DESCRIPTION OF THE DRAWINGS

These and other features of this invention will be more readily understood from the following detailed description of the various aspects of the invention taken in conjunction with the accompanying drawings in which:

FIG. 1 shows an illustrative computer system having a correspondent banking transaction routing system according to embodiments of the present invention.

FIG. 2 shows a model of a correspondent banking network with weighted edges according to embodiments of the invention.

FIG. 3 shows a flow diagram depicting a method according to embodiments of the invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

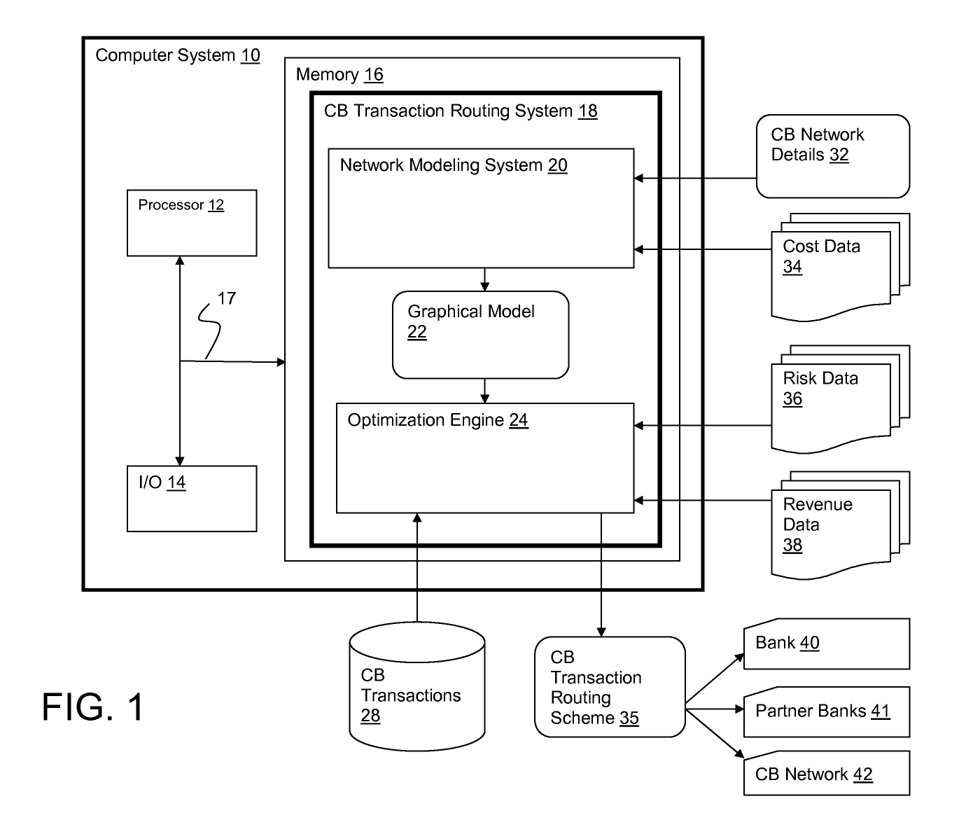

FIG. 1 depicts a computer system 10 having a correspondent bank (CB) transaction routing system 18 for generating a CB transaction routing scheme 35 for an inputted set of CB transactions 28. CB transactions 28 may for example comprise a batch of transactions collected during a given day that require execution within a CB network by some predetermined fulfillment date/time. Although not limited, a typical transaction may comprise a transfer of money from one bank to another. CB transaction routing scheme 35 provides a roadmap of how each of the inputted CB transactions 28 should be routed through the CB network to provide a maximized overall economic benefit, e.g., create the most profit/least cost, manage risk, etc.

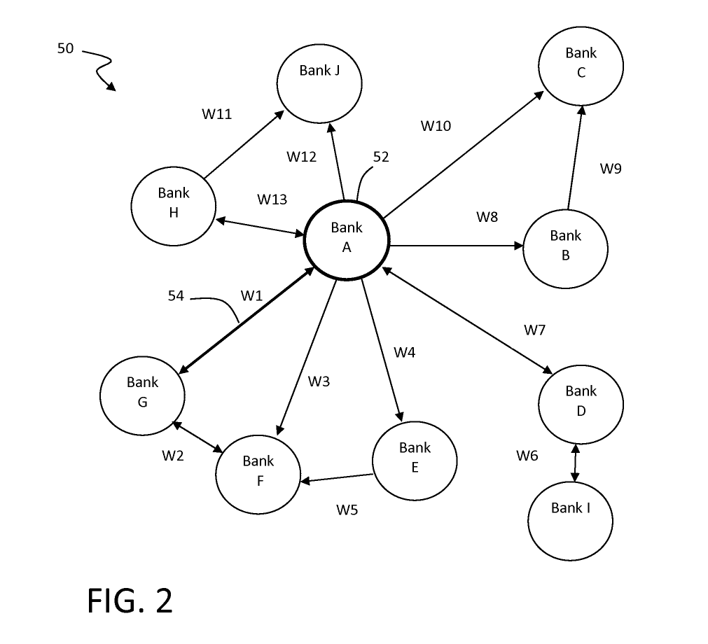

For example, FIG. 2 depicts a CB network 50 comprising a plurality of banks (e.g., Bank A, Bank B, . . . Bank I) that are able to receive and route transactions between and among each other. CB transaction routing system 18 (FIG. 1) models potential transaction routes between and among the set of correspondent banks in CB network 50 and determines the most optimal routes for a set of CB transactions 28. CB transaction routing system 18 generally includes: (1) a network modeling system 20 that inputs CB network details 32 and related cost data 34 and generates a graphical model 22 of the CB network; and (2) an optimization engine 24 that generates a CB transaction routing scheme 35 for a set of CB transactions 28 based on the graphical model 22, risk data 36 and revenue data 38.

CB network details 32 may for example comprise a table of banks in the network, along with details regarding the relationships each bank has with other banks in the network. For instance, most banks in the network will only have relationships with a subset of the other banks in the network, and each of those relationships may only allow for certain types of transactions. For instance, as shown in FIG. 2, Bank F may be equipped to send and receive wire transfers to Bank G, but only receive wire transfers from Bank A and Bank E.

Cost data 34 generally comprises costs associated with executing transactions between and among banks in the network. Illustrative costs include exchange fees, transactions fees, regulation costs, and compliance costs. Exchange fees generally refer to costs incurred when converting money from one currency to another (e.g., Dollars to Euros). Transaction fees generally refer to fees charged by banks to execute a particular transaction. Regulation costs generally refers to government imposed actions that impact the cost of a transaction, e.g., fees, taxes, etc. Compliance costs generally refer to costs associated with adhering to industry rules.

With the CB network details 32 and the inputted cost data 34, network modeling system 20 generates a graphical model 22 of the CB network (e.g., a directed graph) in which each node in the graph denotes a bank and each edge denotes a possible transaction route. Any known computerized tool or system may be utilized by network modeling system 20 to build the graphical model 22, and such tools are widely available in the art. In addition, each edge is assigned a weight that defines a unit cost of transactions along that route. For example, FIG. 2 depicts a directed graph of a network 50 in which Bank A and Bank G are connected with edge 54 having a weight W1. In this case, edge 54 is bidirectional indicating that transactions can flow in both directions between Banks A and G. Similarly, Banks G and F are connected with a bidirectional edge having weight W2; Banks E and F are connected with a one directional edge having weight W5; etc.

Weights W1-W13 may be implemented in any manner. For example, the weight for each edge: (1) may include unit costs for each a plurality of different types of transactions (e.g., wire transfers below $1000 cost x1, wire transfers between $1001-$10,000 cost x2, etc.); (2) may include unit costs on a sliding scale to reflect volume discounts (e.g., 1-5 type A transactions costs y1, 6-10 type A transactions costs y2, etc.); (3) may factor in other variables that impact cost, such as day of the month, time of day, etc.

Referring again to FIG. 1, optimization engine 24 finds a route for each transaction in the set of CB transactions 28 using the graphical model 22 and separately collected cost data 34, risk data 36 and revenue data 38. Risk data 36 generally comprises settlement risks and foreign exchange (FX) risks. Settlement risks include the risk that one party to a FX transaction will deliver the currency it sold to a counterpart, but not receive the currency purchased from its counterpart, resulting in a loss of principal. FX risks involve risks resulting from fluctuating exchange rates in which bad timing causes a bank to lose money. Revenue data 38 includes: (1) service fees charged by the bank to customers to perform given transactions; and (2) FX profits, i.e., profit resulting from fluctuating exchange rates in which good timing causes a bank to make money.

FX risk and FX profit data may for example be derived from: (1) real-time market data that tracks currency trends; (2) external information, such as banking news; (3) time series analysis of currency data and rates in which trends are predicted; and (4) economic data such as market conditions in a given country, fiscal health of a currency based on existing crisis's, etc. Depending on the embodiment, FX risk and profit may be presented as a predictive value along some scale, or in a statistical format such as a distribution of currency exchange predictions over a future period of time. Such a predicted distribution can be determined, e.g., using exponential smoothing that estimates a mean and variance of the distribution based on historical exchange rates and other factors mentioned above.

Settlement risks may for example be derived from transaction histories as well as real-time market data. Transaction histories may include a ratio of good versus bad prior transactions in dealing with a given bank, the amount of money lost dealing with a given bank, etc. Settlement risks may also be presented as predictive values or in a statistical form as described above. In one embodiment, the expected risk for each transaction may be required to be lower than a predetermined threshold.

As noted, a goal of the optimization engine 24 is to create a maximized overall economic benefit, e.g., minimize cost, maximize revenue, and reduce risk by finding the optimal paths for the set of CB transactions 28, such that all transactions 28 are fulfilled before a provided deadline.

Any approach may be utilized by optimization engine 24 to generate an optimized CB transaction routing scheme 35. For example, the CB network can be modeled to analyze cash flow as an electric network in which voltage spreads from the source to a target (i.e., transactions from bank to bank), where each edge can be viewed a resistor that comes with consumption of voltage (i.e., costs of banking). The optimization problem then turns to be how to route the voltage such that the energy is distributed in a desired manner such that all transactions are fulfilled, and loss of voltage (i.e., the cost of correspondent banking) is minimized.

In another embodiment, optimization engine 24 may be characterized as a combinatorial optimization problem or a continuous optimization problem. A combinatorial optimization problem utilizes a quadruple (I, f, m, g), where
I is a set of instances;
given an instance xεI, f(x) is the set of feasible solutions;
given an instance x and a feasible solution y of x, m(x,y) denotes the measure of y, which is usually a positive real.
g is the goal function, and is either min or max.
   The goal is then to find for some instance x an optimal solution, that is, a feasible solution y with

m(x,y)=g{m(x,y′)|y′εf(x)}.

Depending on the situation, the resulting CB transaction routing scheme 35 may be forwarded and used by a single bank 40, a subset of partner banks 41 within a CB network 42 or the CB network 42 itself. For example, a single bank 40 could use CB transaction routing system 18 to determine the best routes for executing a set of transactions required to be performed by the bank 40. In another application, an operator or owner of the CB network 42 may seek to determine the best routes for executing all transactions required to be performed by the CB network 42. In still another application, a group of partner banks 41 within the CB network 42 may seek to determine the best routes for executing the transactions required to be performed by the partner banks 41.

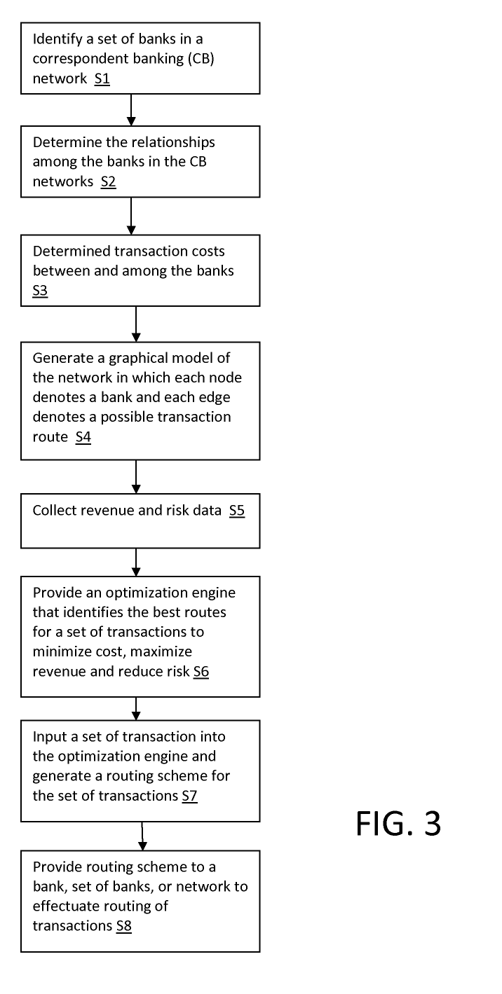

Referring now to FIG. 3, a flow diagram is depicted showing a method of generating a CB transaction routing scheme. At S1, a set of banks in a correspondent banking (CB) network are identified and at S2 the relationships (i.e., possible transaction routes) between and among the banks are identified. At S3, costs between and among the banks are determined for each possible route. At S4, a graphical model of the CB network is generated in which each node denotes a bank and each edge denotes a possible transaction route. As described, each edge is weighted with a unit cost to execute transactions. Next, revenue and risk data associated with each bank and/or transaction route is collected at S5. At S6, an optimization engine is provided that identifies the best routes for a set of transactions to minimize cost, maximize revenue and reduce risk, and at S7, a set of transactions are inputted into the optimization engine to generate a routing scheme for the set of transactions. Finally, at S8, the routing scheme is provided to at least one of a bank, set of banks or a network to effectuate routing of the transactions.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

FIG. 1 depicts an illustrative computer system 10 that may comprise any type of computing device and, and for example includes at least one processor 12, memory 16, an input/output (I/O) 14 (e.g., one or more I/O interfaces and/or devices), and a communications pathway 17. In general, processor(s) 12 execute program code, such as CB transaction routing system 18, which is at least partially fixed in memory 16. While executing program code, processor(s) 12 can process data, which can result in reading and/or writing transformed data from/to memory 16 and/or I/O 14 for further processing. Pathway 17 provides a communications link between each of the components in computer system 10. I/O 14 can comprise one or more human I/O devices, which enable a user to interact with computer system 40. To this extent, CB transaction routing system 18 can manage a set of interfaces (e.g., graphical user interfaces, application program interfaces, etc.) that enable humans and/or other systems to interact with the CB transaction routing system 18. Further, CB transaction routing system 18 can manage (e.g., store, retrieve, create, manipulate, organize, present, etc.) data, such as CB transactions 28, using any solution.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A system for calculating a routing scheme for a set of correspondent banking (CB) transactions, comprising:
a network modeling system that creates a model of a CB network for a set of banks based on existing relationships among and between the banks; and
an optimization engine that generates a CB transaction routing scheme for an inputted set of CB transactions within the CB network, wherein the optimization engine provides an overall maximized economic benefit for executing each of the inputted set of CB transactions based on separately collected cost data, risk data and revenue data.

2. The system of claim 1, wherein the model comprises a directed graph having a plurality of nodes and edges, in which each node denotes a bank and each edge denotes a possible transaction path.

3. The system of claim 2, wherein each edge is weighted with a unit cost for executing a transaction along the edge.

4. The system of claim 1, wherein the inputted cost data includes exchange fee data, transaction fee data, regulation cost data and compliance cost data.

5. The system of claim 1, wherein the inputted risk data includes settlement risk data and foreign exchange risk data.

6. The system of claim 1, wherein the inputted revenue data includes foreign exchange profit data and service fee data.

7. The system of claim 1, wherein the overall maximized economic benefit is a measure of overall revenue less overall cost for executing all of the CB transactions within a required fulfillment deadline.

8. A computer program product stored on computer readable medium, which when executed by a computer system, calculates a routing scheme for a set of correspondent banking (CB) transactions, comprising:
program code that creates a model of a CB network for a set of banks based on existing relationships among and between the banks; and
program code that generates a CB transaction routing scheme for an inputted set of CB transactions within the CB network, wherein the CB transaction routing scheme provides an overall maximized economic benefit for executing the inputted set of CB transactions based on separately collected cost data, risk data and revenue data.

9. The computer program product of claim 8, wherein the model comprises a directed graph having a plurality of nodes and edges, in which each node denotes a bank and each edge denotes a possible transaction path.

10. The computer program product of claim 9, wherein each edge is weighted with a unit cost for executing a transaction along the edge.

11. The computer program product of claim 8, wherein the inputted cost data includes exchange fee data, transaction fee data, regulation cost data and compliance cost data.

12. The computer program product of claim 8, wherein the inputted risk data includes settlement risk data and foreign exchange risk data.

13. The computer program product of claim 8, wherein the inputted revenue data includes foreign exchange profit data and service fee data.

14. The computer program product of claim 8, wherein the overall maximized economic benefit is a measure of overall revenue less overall cost for executing all of the CB transactions within a required fulfillment deadline.

15. A computerized method of calculating a routing scheme for a set of correspondent banking (CB) transactions, comprising:
creating a model of a CB network for a set of banks based on existing relationships among and between the banks; and
generating a CB transaction routing scheme for an inputted set of CB transactions within the CB network, wherein the optimization engine provides an overall maximized economic benefit for executing each of the inputted set of CB transactions based on separately collected cost data, risk data and revenue data.

16. The computerized method of claim 15, wherein the model comprises a directed graph having a plurality of nodes and edges, in which each node denotes a bank and each edge denotes a possible transaction path, and wherein each edge is weighted with a unit cost for executing a transaction along the edge.

17. The computerized method of claim 15, wherein the inputted cost data includes exchange fee data, transaction fee data, regulation cost data and compliance cost data.

18. The computerized method of claim 15, wherein the inputted risk data includes settlement risk data and foreign exchange risk data.

19. The computerized method of claim 15, wherein the inputted revenue data includes foreign exchange profit data and service fee data.

20. The computerized method of claim 15, further comprising: forwarding the CB transaction routing scheme to at least one of a bank, set of banks, or a network, to dictate how the inputted set of CB transactions should be routed.
